(19) United States
(12) Patent Application Publication
(10) Pub. No.: US 2009/0097375 A1
(43) Pub. Date: Apr. 16, 2009

(54) Disk drive device and manufacturing method thereof

(76) Inventors: Kouki Uefune, Kanagawa (JP); Takako Hayakawa, Kanagawa (JP); Teruhiro Nakamiya, Kanagawa (JP); Kazuhide Ichikawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/287,595

(22) Filed: Oct. 10, 2008

(30) Foreign Application Priority Data
Oct. 10, 2007 (JP) 2007-264055

(51) Int. Cl. G11B 33/02; G11B 5/127

(52) U.S. Cl. 369/75.11; 29/603.03; G9B/33.002

(57) ABSTRACT

Embodiments of the present invention provide a simpler, miniaturizable, and highly reliable hermetically sealed enclosure structure in a disk drive device. According to one embodiment, a hard disk drive (HDD) comprises an HDD main unit, a case for housing the HDD main unit, a lid with a feedthrough function for closing an opening of the case, and an FPC connector for interconnecting the HDD main unit and a plurality of pins fixed to the lid. The lid is joined to the case and completely closes the opening of the case. The case and the lid form a sealed enclosure; the internal HDD main unit is housed in the sealed space. Housing the HDD main unit in a sealed space may increase resistance of the HDD to external environmental changes. Sealing low density gas like helium in the sealed space may improve the performance of the HDD.

### CROSS-REFERENCE TO RELATED APPLICATION

The instant nonprovisional patent application claims priority to Japanese Patent Application No. 2007-264055 filed Oct. 10, 2007 and which is incorporated by reference in its entirety herein for all purposes.

### BACKGROUND OF THE INVENTION

Hard disk drives (HDDs) have found widespread application to car navigation systems, moving image recording/reproducing apparatuses, and the like in addition to serving as external storage devices for computers, due to their outstanding characteristics. In such applications, high resistance to environmental changes has been required for outdoor use, for example in a car. A typical HDD has a ventilation hole on its enclosure; air and vapor enter and goes out of the HDD through the hole. As a result, the HDD is significantly affected by external environmental changes. In order to improve the environmental resistance in the HDD, it has been proposed that the enclosure of the HDD has a hermetically sealed structure to prevent gas from entering or going out of the HDD.

HDDs in recent years spin magnetic disks and drive head gimbal assemblies (HGAs) at high speed in response to requests for huger capacity, higher recording density, and higher-speed accessing. As a result, fluctuation of air (turbulence) arises to buffet the magnetic disks and the HGAs. This turbulence buffeting becomes a big disturbance in positioning heads for data recorded on a magnetic disk with high density. This is because that the turbulence occurs at random and it is difficult to estimate its magnitude and cycle so that swift and accurate positioning control becomes complex and difficult. Besides, the turbulence buffeting may cause a noise and impair the quietness of the device.

Another problem caused by influence of the air inside the device due to the high speed spin of the disk is increase of electric power consumption. When the magnetic disk is spun at a high speed, the air around the disk is drawn and spun together. In contrast, the air away from the magnetic disk remains still so that shearing force occurs therebetween to become a load against the spin of the disk. This is called windage loss, which becomes greater as the disk spins at a higher speed. To spin the magnetic disk at high speed against this windage loss, a motor will require a greater power output and more electric power.

Focusing on the fact that the air turbulence and the windage loss are proportional to the density of the gas inside the device, an idea has been proposed to enclose a low density gas in a hermetically sealed HDD instead of air to reduce the air turbulence and the windage loss. Hydrogen, helium, or the like may be an example of the low density gas, but helium is optimum since it is effective, stable, and safe in considering the actual use. A HDD with helium gas sealed therein may solve the above problems and realize swift and accurate positioning control, power saving, and satisfactory quietness.

However, helium has very small molecules and a large diffusion coefficient. Therefore, there has been a problem that an enclosure used in a normal HDD is sealed so poorly that the helium gas leaks out easily. In order to make it possible to seal in low density gas like helium gas, a technique has been proposed in U.S. Patent Publication No. 2005/0068666 (“Patent Document I”).

The structure of a hermetically sealed HDD requires complete hermetic condition so as not to cause gas leakage as well as an enclosure undeformable to air pressure difference between inside and outside the HDD caused by changes in external air pressure or external temperature. To this end, Patent Document 1 discloses a hermetically sealed enclosure formed by laser-welding a base formed by aluminum die-casting and an aluminum cover. Joining the base having high rigidity and the cover having large thickness by laser welding assures rigidity in the enclosure and complete hermetic condition. However, such a structure is not suitable for miniaturization. Since a compact HDD of 2.5 inches or less must be made thinner, it is difficult to design an enclosure having a completely sealed structure and sufficient resistance to loads caused by changes in external air pressure or external temperature.

Japanese Patent Publication No. 5-62446 (“Patent Document 2”) discloses that low pressure gas is enclosed in a hermetically sealed enclosure. Patent Document 2 discloses a structure of an HDD for enclosing a supporting structural member for housing and supporting components of the HDD with a sealing structure. An outer sealing structure assures a complete sealing property so that wide application to the structural design for the inside of the sealing structure may be achieved. However, this sealing structure has a separable structure to be separated into halves and has many joint sections such as a large joint section of these two parts and connecting sections of connectors. Accordingly, the probability of leakage through the joint or connecting sections increases. In addition, the sealed low pressure gas increases loads caused by changes in external air pressure or external temperature so that it is necessary to increase the thickness in the sealing structure to resist the loads. Therefore, a simpler, miniaturizable, and highly reliable structure is required for the sealing enclosure.

### BRIEF SUMMARY OF THE INVENTION

Embodiments of the present invention provide a simple, miniaturizable, and highly reliable hermetically sealed enclosure structure in a disk drive device. According to the embodiment of FIGS. 1(a) and 1(b), a HDD 1 comprises an HDD main unit 10, a case 11 for housing the HDD main unit 10, a lid 12 with a feedthrough function for closing an opening 111 of the case 11, and an FPC connector 13 for interconnecting the HDD main unit 10 and a plurality of pins 122 fixed to the lid 12. The lid 12 is joined to the case 11 and completely closes the opening of the case 11. The case 11 and the lid 12 form a sealed enclosure; the internal HDD main unit 10 is housed in the sealed space. Housing the HDD main unit 10 in a sealed space may increase resistance of the HDD 1 to external environmental changes. Sealing low density gas like helium in the sealed space may improve the performance of the HDD 1.

### BRIEF DESCRIPTION OF THE DRAWINGS

FIGS. 1(a) and 1(b) are exemplary views schematically depicting a configuration of a hermetically sealed HDD according to an embodiment.

FIG. 2 is an exemplary top view schematically depicting a configuration of a HDD main unit according to an embodiment.

FIGS. 3(a) and 3(b) are exemplary views schematically illustrating a structure of a feedthrough according to an embodiment.

FIG. 4 is an exemplary view schematically illustrating the dimensional relationship between a metallic case and the HDD main unit according to an embodiment.

FIG. 5 is an exemplary flowchart illustrating a manufacturing method of a hermetically sealed HDD according to an embodiment.

FIGS. 6(a)-6(c) are exemplary views schematically depicting a configuration of a hermetically sealed HDD according to another embodiment.

FIG. 7 is an exemplary flowchart illustrating a manufacturing method of a hermetically sealed HDD according to another embodiment.

### DETAILED DESCRIPTION OF THE INVENTION

Embodiments of the present invention relate to a disk drive device and a manufacturing method thereof and more particularly to a hermetically sealed disk drive device suitable for enclosing a low density gas like helium gas inside the device and a manufacturing method thereof.

A disk drive device according to an aspect of embodiments of the present invention comprises a metallic case formed of a single metallic plate, a lid joined to the metallic case for closing an opening of the metallic case, a disk drive main unit disposed in a sealed space hermetically enclosed by the metallic case and the lid and being capable of passing through the opening, a plurality of pins fixed to the lid for applying signal interface between the disk drive main unit and an external, and low density gas enclosed in the sealed space. Forming a hermetically sealed enclosure by the metallic case and the lid accomplishes a simpler, miniaturizable, and highly reliable enclosure structure in a disk drive device.

The inner pressure inside the space may be greater than the outer pressure at sea level and at a temperature of 25° C. This achieves thinner wall thickness of the metallic case. The low density gas may be helium gas, and the inner pressure inside the space may be 1.3 atms or more at sea level and at a temperature of 25° C. Use of helium gas allows easier leak inspection and the inner pressure under this condition effectively prevents deformation of the metallic case in the use environment of the disk drive device.

In one example, the lid is welded to the metallic case and has a base plate with a plurality of holes formed thereon, and each of the plurality of pins is fixed to each of the plurality of holes with a sealing member. This achieves a simpler lid structure. Or, in another example, the lid comprises a base plate welded to the metallic case, and a feedthrough plate joined to the base plate so as to close an opening of the base plate and having a plurality of holes formed thereon, and each of the plurality of pins is fixed to each of the plurality of holes with a sealing member. The presence of the base plate and the feedthrough plate expands the range of choices for materials.

The metallic case has a top surface, a bottom surface, and a plurality of side surfaces with smaller areas than the top and bottom surfaces, and the lid is joined to the metallic case so as to close an opening formed on one of the plurality of side surfaces. This achieves shorter length in the joint section to improve the reliability.

Another aspect of embodiments of the present invention is a method for manufacturing a disk drive device. This method manufactures a disk drive device main unit. It disposes the disk drive device main unit in a metallic case formed of a single metallic plate through an opening of the metallic case. It connects the disk drive device main unit and a pin fixed to a lid with a cable. It disposes the lid on the metallic case so as to close the opening, and welding the lid and the metallic case. It encloses low density gas in a sealed space hermetically enclosed by the metallic case and the lid. This accomplishes manufacture of a simpler, miniaturizable, and highly reliable enclosure structure. The low density gas may be injected in the inner space enclosed by the lid and the metallic case through a hole formed on the metallic case after welding the lid and the metallic case. This increases manufacturing efficiency.

Embodiments of the present invention accomplish a sealing enclosure with a simpler, miniaturizable, and highly reliable structure in a disk drive device.

Hereinafter, particular embodiments of the present invention will be described. For clarity of explanation, the following description and the accompanying drawings contain omissions and simplifications as appropriate. Throughout the drawings, like components are denoted by like reference numerals, and their repetitive description is omitted if not necessary for the sake of clarity. In one embodiment, a hard disk drive (HDD) will be described as an example of a disk drive device. An HDD according to one embodiment comprises an HDD main unit and a sealing enclosure for housing the HDD main unit. A feature of an embodiment of the present invention is the structure of this sealing enclosure.

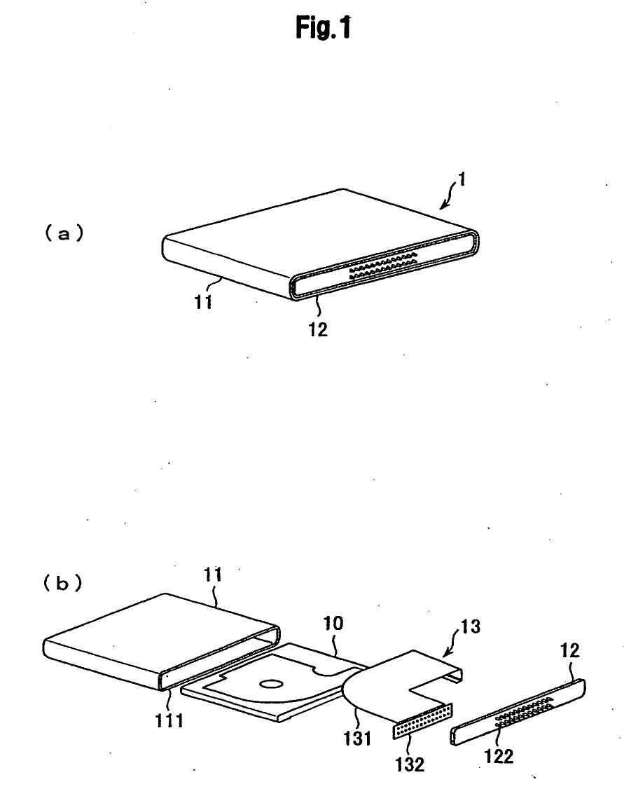

FIG. 1(a) is a perspective view schematically depicting an entire configuration of a hermetically sealed HDD 1 according to one embodiment, and FIG. 1(b) is an exploded perspective view thereof. As shown in FIG. 1(b), the HDD 1 comprises an HDD main unit 10, a case 11 for housing the HDD main unit 10, a lid 12 to close an opening 111 of the case 11, and an FPC connector 13, which is an assembly of a flexible printed circuit (FPC) 131 for interconnecting the HDD main unit 10 and a plurality of pins 122 fixed to the lid 12 and a connector 132.

As shown in FIG. 1(a), the lid 12 is joined to the case 11 to completely close the opening of the case 11. The case 11 and the lid 12 constitute a hermetically sealed enclosure, and the HDD main unit 10 inside thereof is housed in the sealed space. Housing the HDD main unit 10 in the sealed space may improve the resistance of the HDD 1 to external environmental changes. Enclosing low density gas like helium into the sealed space may improve the performance of the HDD 1.

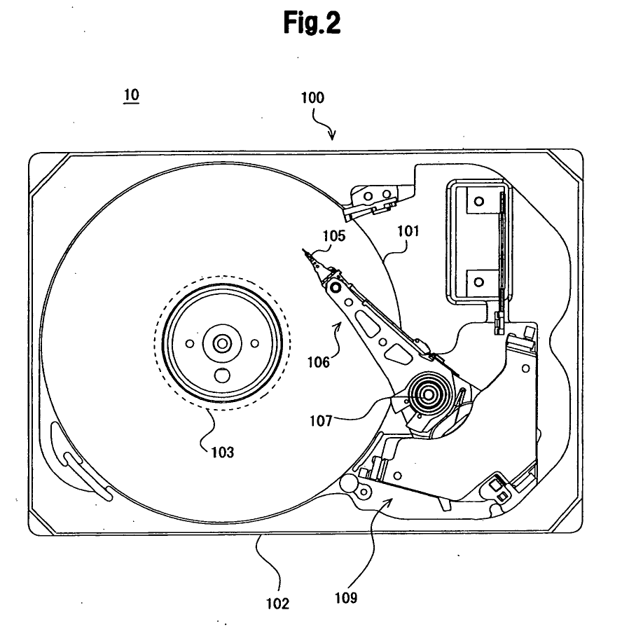

Before describing the structure of the enclosure of the present embodiment, the structure of the HDD main unit 10 will be described referring to FIG. 2. The HDD main unit 10 has the same structure as a normal HDD. Specifically, the HDD main unit 10 comprises a head disk assembly (HDA) 100 and a control circuit board (not shown) fixed to the outer bottom surface of the HDA 100. On the control circuit board, circuit elements for controlling operation of the HDA 100 are mounted. The FPC 131 is connected to a connector on the control circuit board. In FIG. 2, a head slider 105 writes to and/or reads from a magnetic disk 101.

An actuator 106 supports and moves the head slider 105. The actuator 106 is driven by a voice coil motor (VCM) 109 as a driving mechanism and pivots about a pivotal shaft 107. An assembly of the actuator 106 and the VCM 109 is a moving mechanism of the head slider 105. The magnetic disk 101 is supported and is spun at a specific angular rate by a spindle motor (SPM) 103, which is fixed to a base 102. The actuator 106 moves the head slider 105 to above a data area on the surface of the spinning magnetic disk 101 for data retrieval from/data write to the magnetic disk 101. An opening of the base 102 is covered by a top cover (not shown).

Returning to FIG. 1(b), the FPC connector 13 interconnects the control circuit board of the HDD main unit 10 and the pins 122 fixed to the lid 12. A cable to a host is connected to the outside of the pins 122. The FPC connector 13 transmits signals between the external host and the HDD main unit 10 and electric power for operation of the HDD main unit 10. The FPC 131 is physically connected to a connector of the control circuit board, and the connector 132 is fitted and physically connected to the pins 122 on the lid 12.

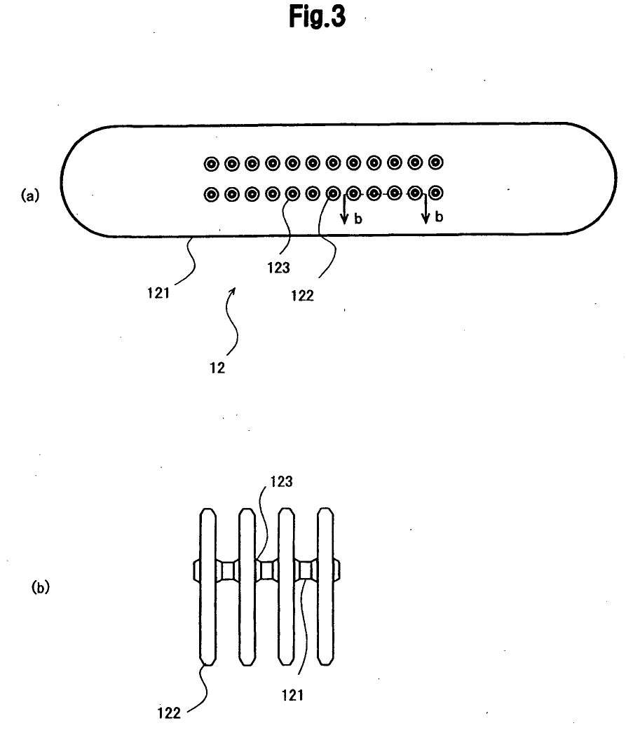

The lid 12 of the present embodiment functions as a feedthrough. FIG. 3(a) is a top view of the lid 12 and FIG. 3(b) is a cross-sectional view along the section line b-b in FIG. 3(a). The lid 12 comprises a flat plate-like shaped base plate 121 and a plurality of pins 122 penetrating through the base plate 121 and supported vertically from the base plate 121. Sealing members 123 of glass, ceramic, or the like fill the peripheries around the pins 122 so that the gaps between the pins 122 and the base plate 121 are sealed up.

In this example, the base plate 121 is a single plate made of a single metallic material. The material of the base plate 121 is selected in consideration of the thermal expansion coefficient of the sealing member 123 made of glass or the like. If the thermal expansion coefficient of the material of the base plate 121 greatly differs from the one of the sealing member 123, the sealing member 123 may receive stress with change in the external temperature to crack.

To this end, the base plate 121 is preferably made of steel or stainless steel. The thermal expansion coefficient of the sealing member 123 of glass or the like is about 10 ppm/° C. at the maximum, while the one of steel is about 13 to 17 ppm/° C.; the difference between them is smaller compared to the thermal expansion coefficient of aluminum die-casting material of about 20 ppm/° C. so that the probability of the crack in the sealing member 123 due to the stress may be reduced.

As shown in FIG. 1(a), the lid 12 is joined to the case 11 so as to close the opening 111 of the case 11. One method for joining is welding. Although the lid 12 may be soldered to the case 11, welding may be in the point of reliability on firm joining. Typically, the base plate of the lid 12 and the case 11 are joined by laser-welding. The material of the case 11 depends on the joining method to the lid 12. In the case of soldering, a material different from the one of the base plate 121 of the lid 12 may be selected for the case 11. For weight saving of the HDD 1, the case 11 may be made of metal mainly composed of aluminum, such as aluminum, aluminum alloy, or the like. In the case of welding, the case 11 is may be made of the same material as the base plate 121, namely steel or stainless steel.

As shown in FIG. 1(b), the case 11 has an opening 111 on one surface thereof and the other surfaces are constituted by a continuous wall. The opening 111 is substantially rectangular-shaped and its corners are curved. No joining sections are provided except for the opening 111 in the case 11 to increase the sealing reliability on the HDD 1. The case 11 may be manufactured by forming a single continuous plate. Typically, the case 11 is manufactured by the metallic thin plate drawing.

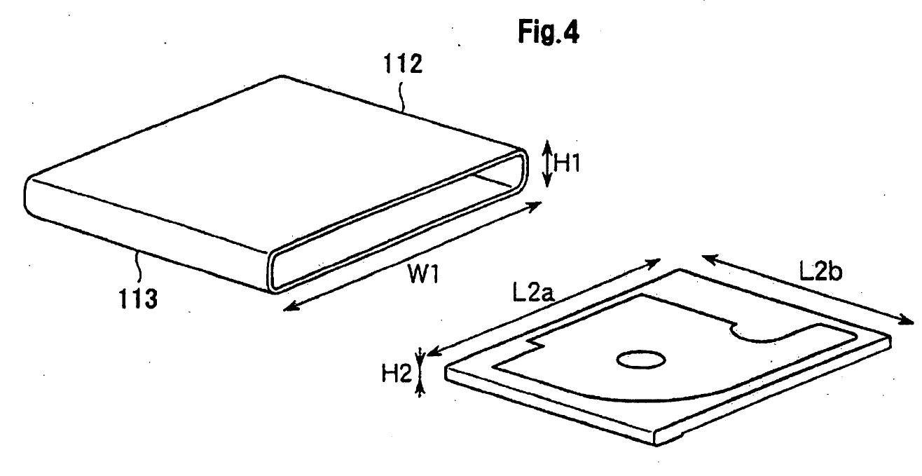

The HDD main unit 10 is inserted into the case 11 through the opening 111. Therefore, it is necessary that the opening 111 be large enough in size for the HDD main unit 10 to pass through. As shown in FIG. 4, it is necessary that the size (width) W1 in the longer side of the opening 111 and the size (height) H1 in the shorter side be larger than the width and the height of the HDD main unit 10 respectively, viewed from any side of the HDD main unit 10. The HDD main unit 10 has a substantially cuboid shape and the size (height or thickness) H2 in the direction vertical to the recording surface of the magnetic disk 101 is smaller than the two edges L2a and L2b parallel to the recording surface and is smallest. One of the two edges parallel to the recording surface (L2a) is loner than the other (L2b). Specifically, the two edges (L2a) extending in the direction in which the magnetic disk 101 and the actuator 106 are arranged are longer than the other two edges (L2b).

The HDD main unit 10 has two surfaces (the top surface and the bottom surface) parallel to the recording surface and four side surfaces vertical to the recording surfaces. The area of the two of the top and bottom surfaces is larger than the one of the four side surfaces. The width L2a of the two side surfaces facing both of the magnetic disk 101 and the actuator 106 of the four side surfaces are larger than the width L2b of the other two side surfaces. The two side surfaces facing the both of the magnetic disk 101 and the actuator 106 are defined by the edges (L2a) extending in the direction in which the magnetic disk 101 and the actuator 106 are arranged and the edges (H2) vertical to the recording surface.

The shape of the case 11 is a substantially cuboid like the HDD main unit 10 and the dimensions of its internal space are larger than the corresponding dimensions of the HDD main unit 10 so as to house the HDD main unit 10. The case 11 has six surfaces including the opening 111, and the top surface 112 and the bottom surface 113 are larger than the four side surfaces. When the HDD main unit 10 has been set in the case 11, the top surface, the bottom surface, and the four side surfaces of the case 11 face the top surface 112, the bottom surface 113, and the four side surfaces of the HDD main unit 10, respectively.

The opening 111 for inserting the HDD main unit 10 therethrough may be formed on a surface corresponding to one of the four side surfaces. If either one of the top surface 112 and the bottom surface 113 having large areas is the opening 111, the joining length between the lid 12 and the case 11 becomes larger to increase the possibility of leakage to that extent. The case 11 has the opening 111 on one of the side surfaces whose perimeters are smaller than those of the top and bottom surfaces 112 and 113 so that the joining length of the lid 12 and the case 11 becomes smaller to increase the reliability.

In the example of FIG. 1(b), the opening 111 is formed on a side surface on the longer edge of the case 11. The HDD main unit 10 is inserted from the side surface on the longer edge, namely the side surface facing both of the magnetic disk 101 and the actuator 106, into the case 11. The width W1 of the opening 111 is larger than the width L2 in the longer side of the HDD main unit 10; and the height H1 of the opening 111 is larger than the thickness H2 of the HDD main unit 10.

In order for the lid 12 to completely close the opening 111, it is necessary that the outline of the base plate 121 be substantially the same as the outline of the opening 111, or be larger than the outline of the opening 111. The base plate 121 may completely cover the opening 111 when placed on the edge of the case 11 defining the opening 111 so as to make the joining by welding or soldering easier. As shown in FIG. 3(a), the corners of the base plate 121 may be formed by curves along the corners of the opening 111. This reduces the possibility of failure in joining as well as the possibility of a crack at the joint section due to concentration of stress.

In one embodiment, the inner pressure inside the sealed enclosure formed by the case 11 and the lid 12 is higher than the outer pressure (1 atm) at sea level and at a normal temperature (25° C.). More preferably, the inner pressure inside the sealed enclosure is always the same as the outer pressure or higher under the designed use condition of the HDD 1 with respect to the temperature and the air pressure. Thereby, even if the wall thickness of the case 11 is made thinner, the case 11 will not be deformed so that the weight saving and easier manufacturing of the case 11 may be achieved. Specifically, the inner pressure inside the sealed enclosure may be 1.3 atms or more at sea level and at a normal temperature (25° C.).

The gas enclosed in the sealed enclosure preferably contains low density gas whose density is lower than air. Although hydrogen or helium may be proposed for the low density gas to be used, helium is optimum because of much effectiveness, stability, and safeness. Hereinafter, an example using helium will be described. A ventilation hole is provided on the HDD main unit 10 and the sealed helium gas enters the inside of the HDD main unit 10 therethrough. Increasing the ratio of helium gas in the sealed enclosure may suppress the air turbulence and the windage loss caused by the spin of the magnetic disk 101 to improve the performance and power consumption of the HDD body 10. Besides, since helium gas is excellent in thermal conductance, it may increase the heat dissipation effect of the HDD main unit 10.

Mixed gas of helium and other gas like nitrogen may be enclosed in the sealed enclosure. Helium gas may be detected more easily than the other gas so that leak inspection may be conducted easily after joining the case 11 and the lid 12. One percent of helium in the sealed enclosure is enough for the leak inspection. Larger percentage of helium gas in the sealed enclosure may be used in the point of heat dissipation, performance of the HDD main unit 10, and improvement in power consumption. Typically, the percentage of the helium is 10% or more, or 50% or more.

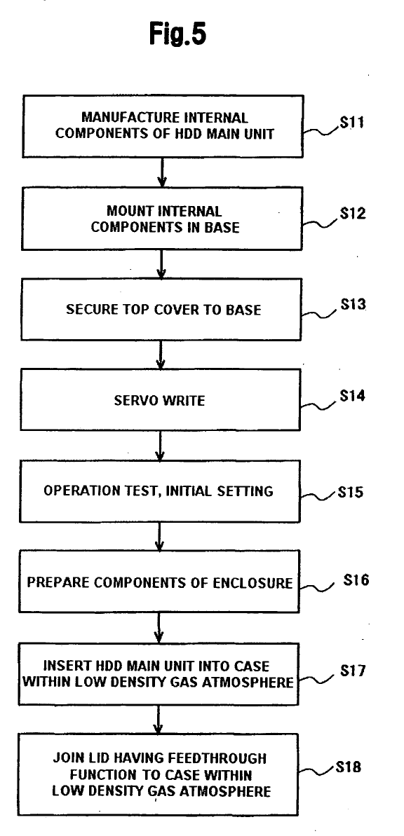

Next, a manufacturing method of the HDD 1 will be described referring to the flowchart of FIG. 5. First, internal components of the HDD main unit 10 are manufactured (S11). Specifically, a head stack assembly (HSA) of an assembly of an actuator 106 and a head slider 105, an SPM 103, a magnetic disk 101, and the like are manufactured. Next, the above internal components are mounted in a base 102 (S12). Then, a top cover is secured to the base 102 to form an HDA (S13). The HDA is connected to a servo writer and servo write is performed on the magnetic disk 101 (S14). After the servo write, a control circuit board is mounted on the HDA and various tests, settings, defect registration, and the like are performed (S15). Thus, the HDD main unit 10 is finished.

Aside from the HDD main unit 10, an FPC connector 13, a case 11, and a lid 12 having a feedthrough function are prepared (S16). The FPC connector 13 is connected to the HDD main unit 10 and the HDD main unit 10 is inserted into the case 11 through an opening 111 to be set in the case 11 within an atmosphere of the gas to be sealed in the sealed enclosure (S17). Pins 122 of the lid 12 are connected to the FPC cable 13 and the lid 12 is placed on the case 11 so as to cover the opening 111, then the base plate 121 of the lid 12 and the case 11 are joined by laser welding (S18). When the lid 12 has been joined to the case 11, the gas has been sealed in the sealed enclosure under pressurized condition. Then, a leak inspection on the joint section is conducted and the manufacture of the HDD 1 ends. Thus, the HDD 1 having a hermetically sealed structure may be manufactured efficiently in a simple structure.

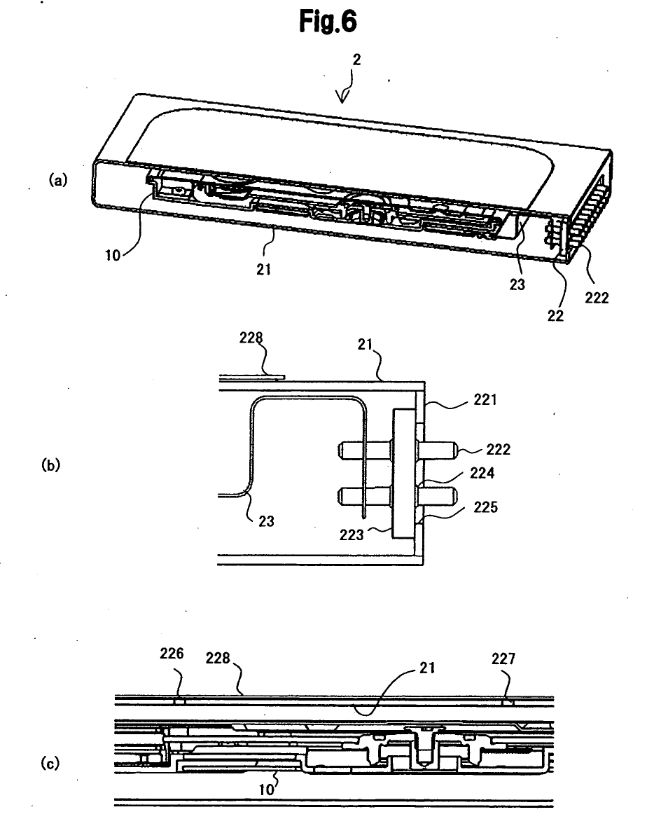

Next, a HDD 2 according to another embodiment of the present invention will be described. The HDD 2 of the present embodiment is equipped with an HDD main unit 10 in a hermetically sealed enclosure. The structure of the HDD main unit 10 is the same as the above-described other embodiment. The present embodiment is different in the shape of the case, the position of the opening of the case, and the structure of the lid having a feedthrough function. FIG. 6(a) depicts an entire and a cross-sectional configuration of the HDD 2 according to the present embodiment. The HDD 2 comprises an HDD main unit 10, a case 21, a lid 22 having a feedthrough function, and an FPC 23.

The FPC 23 electrically and physically connects the HDD main unit 10 and pins 222 of the lid 22. The position of the lid 22 connected to the case 21 is different from the above-described other embodiment. In the present example, the lid 22 is joined to the side surface having the shortest perimeter, namely having the smallest area. The HDD main unit 10 is inserted into the case 21 through the side surface having the shortest perimeter, namely having the smallest area, and is set in the case 21 without turning. This achieves a shorter joint length between the case 21 and the lid 22 after disposing the HDD main unit 10 to increase the reliability.

FIG. 6(b) is a cross-sectional view of the lid 22 joined to the case 21. The lid 22 comprises a base plate 221, a feedthrough plate 223 joined to the base plate 221, and a plurality of pins 222 fixed to the feedthrough plate 223. The plurality of pins 222 penetrate through and are vertically supported by the feedthrough plate 223. A sealing member 224 made of glass, ceramics, or the like fills the periphery around each of the pins 222 so that each gap between the pin 222 and the feedthrough plate 223 is sealed up.

The feedthrough plate 223 is a plate made of a metallic material. The material for the feedthrough plate 223 is selected in consideration of the thermal expansion coefficient of the sealing member 224 made of glass or the like. The feedthrough plate 223 may be made of steel or stainless steel. This reduces the probability of a crack in the sealing member 224. The feedthrough plate 223 is joined to the surface of the base plate 221. The joining method may be soldering, pulsed electric current bonding, or FSW joining.

An opening 225 is provided at the center of the base plate 221 and the feedthrough plate 223 is joined so as to completely cover the opening 225. That is, the outline of the feedthrough plate 223 is larger than the opening 225 and may close the whole opening 225 when the feedthrough plate 223 is superimposed on the base plate 221. The plurality of pins 222 pass through the opening 225 and project to the reverse side of the feedthrough plate from the joint surface. In FIG. 6(b), the feedthrough plate 223 is joined to the inner side of the base plate 221 (the inside of the sealed space), but may be joined to the outer side.

The base plate 221 may be joined to the case 21 by welding. Therefore, the base plate 221 and the case 21 may be made of the same metallic material. For weight saving of the HDD 2, the base plate 221 and the case 21 are made of metal mainly composed of aluminum, such as aluminum or aluminum alloy. Since the pins 222 are fixed to the feedthrough plate 223 with the sealing members 224, the material of the base plate 221 may be selected more freely.

FIG. 6(c) is a partial cross-sectional view of the case 21 and the HDD main unit 10. The case 21 according to the present embodiment has holes 226 and 227 for injecting low density gas. In manufacturing the HDD 2, low density gas is injected into the inside of the enclosure through these holes 226 and 227 after joining the lid 22 to the case 21. This eliminates the necessity of manufacturing the HDD 2 within the low density gas atmosphere to increase the efficiency in the manufacturing steps. To prevent comings and goings of the gas, the diameters of the holes 226 and 227 are preferably 1 mm or less. Since these holes 226 and 227 are sealed with a metallic tape 228 of aluminum for example, the comings and goings of the gas therethrough may be securely prevented.

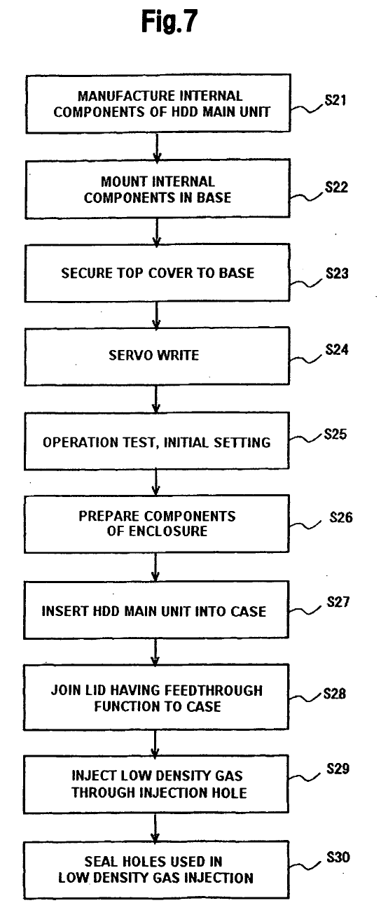

Next, a manufacturing method of the HDD 2 will be described referring to the flowchart of FIG. 7. The steps S21 to S25 are the same as the flowchart of FIG. 5 and the explanation will be omitted. After the manufacture of the HDD main unit 10, the FPC 23, the case 21 and the lid 22 having a feedthrough function are prepared (S26), aside from the HDD main unit 10. The FPC 23 is connected to the HDD main unit 10 and the HDD main unit 10 is inserted through the opening of the case 12 to set the HDD main unit 10 inside the case 12 (S27).

The pins 222 of the lid 22 are connected to the FPC 23, the lid 22 is disposed on the case 12 so as to cover the opening of the case 21 through which the HDD main unit 10 is inserted, and the base plate 221 of the lid 22 is joined to the case 21 by laser welding (S28). After completion of the joining of the lid 22 and the case 21, low density gas is injected into the inside of the enclosure through the holes 226 and 227 of the case 21 (S29). Specifically, while ejecting the inside gas through the hole 226, the gas is injected into the inside of the enclosure through the other hole 227. At this time, the low density gas is injected under pressure so as to control the final internal pressure to be a desired air pressure. The value of the final internal pressure is the same as the above-described other embodiment. After completion of the gas injection, the holes 226 and 227 are sealed with a metallic tape 228 (S30), and if the HDD 2 passes the leak inspection, the manufacture of the HDD 2 ends. In this manner, the HDD 2 with a hermetically sealed structure may be manufactured.

As set forth above, the present invention is described by way of particular embodiments but is not limited to the above embodiments. A person skilled in the art may easily modify, add, and convert the each element in the above embodiments within the scope of the present invention. For example, embodiments of the present invention are particularly useful to an HDD but may be applied to a magnetic disk drive device other than an HDD.

What is claimed is:

1. A disk drive device comprising:
a metallic case formed of a single metallic plate;
a lid joined to the metallic case for closing an opening of the metallic case;
a disk drive main unit disposed in a sealed space hermetically enclosed by the metallic case and the lid and being capable of passing through the opening;
a plurality of pins fixed to the lid for applying signal interface between the disk drive main unit and an external; and
low density gas enclosed in the sealed space.

2. The disk drive device according to claim 1, wherein
the inner pressure inside the space is greater than the outer pressure at sea level and at a temperature of 25° C.

3. The disk drive device according to claim 1, wherein
the low density gas is helium gas; and
the inner pressure inside the space is 1.3 atms or more at sea level and at a temperature of 25° C.

4. The disk drive device according to claim 1, wherein
the lid is welded to the metallic case and has a base plate with a plurality of holes formed thereon; and
each of the plurality of pins is fixed to each of the plurality of holes with a sealing member.

5. The disk drive device according to claim 1, wherein
the lid comprises a base plate welded to the metallic case, and a feedthrough plate joined to the base plate so as to close an opening of the base plate and having a plurality of holes formed thereon; and
each of the plurality of pins is fixed to each of the plurality of holes with a sealing member.

6. The disk drive device according to claim 1, wherein
the metallic case has a top surface, a bottom surface, and a plurality of side surfaces with smaller areas than the top and bottom surfaces; and
the lid is joined to the metallic case so as to close an opening formed on one of the plurality of side surfaces.

7. A method for manufacturing a disk drive device comprising:
manufacturing a disk drive device main unit;
disposing the disk drive device main unit in a metallic case formed of a single metallic plate through an opening of the metallic case;
connecting the disk drive device main unit and a pin fixed to a lid with a cable;
disposing the lid on the metallic case so as to close the opening, and welding the lid and the metallic case; and
enclosing low density gas in a sealed space hermetically enclosed by the metallic case and the lid.

8. The method for manufacturing a disk drive device according to claim 7, wherein
the low density gas is injected in the inner space enclosed by the lid and the metallic case through a hole formed on the metallic case after welding the lid and the metallic case.

9. The method for manufacturing a disk drive device according to claim 7, wherein
the inner pressure inside the sealed space is greater than the outer pressure at sea level and at a temperature of 25° C.

10. The method for manufacturing a disk drive device according to claim 9, wherein
the low density gas is helium gas; and
the inner pressure inside the sealed space is 1.3 atms or more at sea level and at a temperature of 25° C.
